(19) United States
(12) Patent Application Publication
(10) Pub. No.: US 2006/0072999 A1
(43) Pub. Date: Apr. 6, 2006

(54) Dual purpose vehicle tow lift

(76) Inventor: Jerry E. Manley SR., Virginia Beach, VA (US)

Correspondence Address: M. Bruce Harper, Suite 1700, 222 Central Park Avenue, Virginia Beach, VA, 23462, US

(21) Appl. No.: 11/193,859

(22) Filed: Jul. 29, 2005

Related U.S. Application Data
(60) Provisional application No. 60/592,998, filed on Jul. 30, 2004.

(51) Int. Cl. B60P 3/12

(52) U.S. Cl. 414/563

(57) ABSTRACT

A dual purpose tow lift is described that enables a primary vehicle to lift and tow a secondary vehicle and, when not used for towing, provides a supplemental rear bumper. The tow lift includes three major portions of a sway member, a telescope member, and a swing member. The sway member pivotally attaches to the primary vehicle and is slideably engaged with a telescoping member, which extends for towing and retracts for storage. A swing member is pivotally attached to telescope member such that when the telescope member is extended, wheel mounts attached to swing member may engage the tires of the secondary vehicle. When the sway member is locked in the stored position and when the telescope member is substantially retracted into said sway member, then the swing member rests in a transverse position near the rear bumper of the primary vehicle. The swing member is configured to align with the rear bumper and to provide additional protection of the primary vehicle rear end in the event of a rear end collision.

### CROSS REFERENCE TO RELATED APPLICATION

The present application claims priority from U.S. Provisional Application Ser. No. 60/592,998, filed Jul. 30, 2004.

### BACKGROUND OF THE INVENTION

### Field of the Invention

This invention relates to the field of vehicle towing. In particular, this invention is a dual purpose tow lift that enables the towing of vehicles and, when not in use towing, provides a supplemental rear bumper.

### BACKGROUND

In the field of vehicle towing, there have been a number of efforts to develop devices that would enable the owner of one vehicle to tow another vehicle. The need often arises when an owner of a typically larger vehicle, such as a motor home, truck, van, or other recreational vehicle, desires to travel to a destination and upon arrival, park the large or primary vehicle at a support or camping facility designed for such purposes. Because the larger vehicle may be difficult to maneuver, expensive to operate, and may also serve as a mobile residence, the owner may prefer to leave it undisturbed in the facility for a significant time during the visit. However, the owner may also desire transportation about the locale of the destination for a variety of reasons, such as exploration, tourism, or collecting supplies to support an extended stay. Some drivers bring bicycles or motorcycles, which may be suitable for some of these purposes. However, others may desire the convenience and protection afforded by a more substantial conveyance as their secondary vehicle, such as a small automobile. Examples of such devices include U.S. Pat. No. 4,761,015 to Carr, U.S. Pat. No. 4,993,910 to Rigg, and U.S. Pat. No. 5,516,140 to Hinte.

One category of such devices is that of the automobile tow lift. Of the above examples, '015 to Carr and '910 to Rigg disclose tow lifts. Tow lifts are devices that typically permit a driver to lift a set of wheels of a secondary vehicle and to tow it from one destination to another. These devices fall within a larger set of towing devices that include towing bars, frames, or other towing rigs, which are usually adapted to mate with a ball shaped towing hitch. The ability to lift distinguishes tow lifts as being more protective of the towed vehicle's suspension and tires. In contrast to trailers and dollies, a tow lift allows a driver to move in both forward and reverse directions while towing, and to turn both the primary and the secondary vehicle around without disconnecting the secondary vehicle. In some cases, these maneuvers may be accomplished with the same degree of difficulty as driving a single vehicle.

However, a disadvantage of existing efforts is that the structure employed to implement a tow lift is directed to the single function of towing a secondary vehicle. Many prior implementations are costly and involve substantial or complicated vehicle modifications; for example, the proprietary coupling towing ball of the invention disclosed in '910 to Rigg requires modification of both the towing and the towed vehicles. Thus, when a driver travels without a secondary vehicle, the tow lift represents a cost and additional weight of limited benefit. Some existing designs of tow lifts do permit disassembly of portions of the tow lift, such as the device disclosed by Rigg, which can reduce weight when not in use.

It would be advantageous if a tow lift that was not being used to tow a secondary vehicle were to serve some additional purpose for the benefit of the primary vehicle, improving its overall value. Not provided in the state of the art is a tow lift that is configured to supplement the primary vehicle's safety structure. Bumpers are directed to absorbing the shock of an impact and reducing vehicle damage. However, federal bumper standards do not apply to vehicles other than passenger automobiles, meaning that motor homes, recreational vehicles, and light trucks may have bumpers of varying or lower quality.

### SUMMARY OF THE INVENTION

The present invention is a tow lift adapted to function as a supplemental bumper system when positioned in the stored position and not towing a secondary vehicle. Further, it is an object of the present invention to be capable of simple and easy disassembly.

The tow lift of the present invention is a structure detachably fastened to the undercarriage of a primary vehicle that is capable of lifting a pair of wheels (or, depending on the embodiment, vehicle end or wheel area) of a secondary or towed vehicle, which enables the primary vehicle to tow a secondary vehicle. The straightforward design of the present invention enables easy assembly or disassembly. Further, when not required for towing, this invention may be retracted (automatically or manually) into a position in the low rear of the vehicle so that a portion of the device is in a stored or bumper position, where it is presented in a way so as to act as a supplemental bumper.

### DRAWINGS

A more complete description of the subject matter of the present invention and the advantages thereof, can be achieved by the reference to the following detailed description by which reference is made to the accompanying drawings in which:

FIG. 1 is a side perspective of the present invention;

FIG. 2 is a bottom view of the present invention in a stored position;

FIG. 3 is a view of the present invention towing a secondary vehicle;

FIG. 4 is a top view detail of the swing member with wheel mounts installed;

FIG. 5 is a rear view of the present invention in a lowered position;

FIG. 6 is a rear view of the present invention in a stored position, with swing member supplementing the bumper of the primary vehicle; and

FIG. 7 is a view of a meshed flat box as an example of alternative storage arrangements.

Element List

10 Sway member

11 Sway member pivot shaft

12 Sway member pivot hole

16 Sway member locking pin

17 Sway member locking hole

20 Mounting bar

21 Sway member mount

22 Mount pivot hole

26 U-bracket

27 U-bracket locking holes

27S U-bracket locking hole—storage

27T U-bracket locking hole—tow

30 Telescope member

31 Telescope locking pin

32 Telescope locking hole

33 Swing mount

40 Swing member

40L Swing member left end

40R Swing member right end

41 Swing member pivot shaft

42 Swing member pivot hole

46 Wheel mount hole

48 Rubberpads

51 Wheel mount locking pin

52 Wheel mount locking hole

55 Wheel mount

55F Front end of wheel mount

55L Left wheel mount

55R Right wheel mount

60 Hydraulic piston

70 Supports

80 Stops

85 Isolator piston

90 Flat box

91 Box members

100 Tow lift

200 Primary vehicle

220 Rear bumper

300 Secondary vehicle

301 Secondary vehicle tires

As described above, tow lifts offer ease of towing with acceptable maneuverability of the primary vehicle, such as a motor home. The present invention is a tow lift that also provides ease of assembly and improved safety when not in use. This tow lift enhances the rear end protection of the primary vehicle when the invention is in a stored or bumper position.

Those skilled in the art will appreciate that there are a wide variety of structures encompassed by the present invention. The dimensions and materials of construction will vary depending on the application. In general, a tow lift is proportional to the width and clearance of the primary vehicle chassis. Materials should be sufficiently strong and tough to serve the intended purpose, with accepted flexure of members when under loading as contemplated by the application. The following is a simple and inexpensive embodiment. The present invention may be considered in several major portions, discussing first their towing functions and second their supplemental bumper functions.

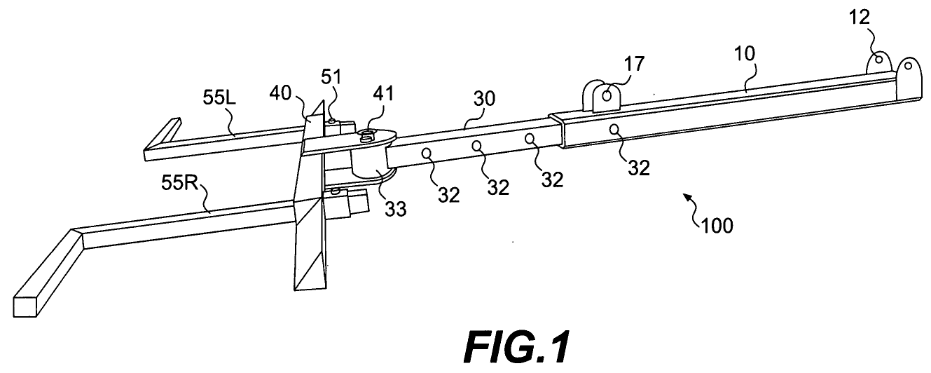

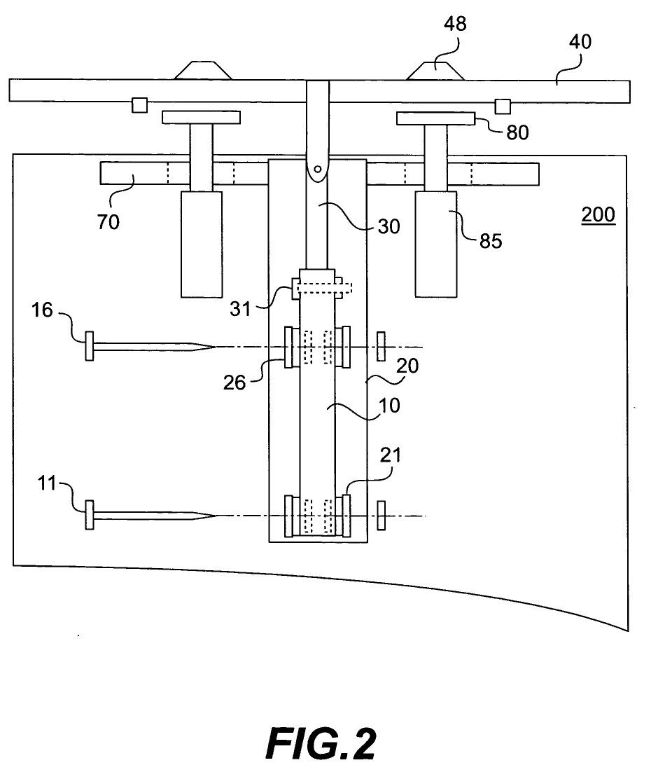

With reference to FIG. 1, a first portion of the tow lift 100 of the present invention is sway member 10. This portion may be adapted for use with a variety of anti-sway structures, such as friction sway control, additional rigid members, or dual cam sway control. Sway member 10 may be made from a variety of appropriately strong and tough materials; in this example, sway member 10 is a simple and inexpensive rectangular tube. Solid members or other cross sections may serve as well, depending on the application. Sway member 10 is pivotally fastened in a substantially longitudinal direction (i.e., the longitudinal axis runs front to rear) to the undercarriage of the primary vehicle 200. The pivot axis is oriented transversely (i.e., the transverse axis runs side to side) with respect to primary vehicle 200. In the example of FIG. 2, sway member mount 21 defines a bearing in mount pivot hole 22 (not shown) for an independent sway member pivot shaft 11. Alternatively, pivot shaft 11 may be integrated into sway member 10, sway member mount 21 may include a notch or other support.

Sway member mount 21 may be fastened to primary vehicle 200 using methods known in the art. For this example, sway member mount 21 is fastened to a mounting bar 20, which in turn is fastened to the underside of the chassis of primary vehicle 200. Fastening may be by bolt, weld, screw, ties, etc. Mounting bar 20 is shaped to conform to the undercarriage structure of primary vehicle 200, and may include or support such other structure as described below. If primary vehicle 200 undercarriage provides sufficient structure for mounting the items described herein, then that embodiment may not require a separate mounting bar, as will be acknowledged by those skilled in the art. In this example, sway member mount 21 is fastened to mounting bar 20, with the axis of pivot transversely oriented. Sway member mount 21 is adapted to receive sway member pivot shaft 11 into mount pivot hole 22. Sway member 10 is also adapted to receive sway member pivot shaft 11 into sway member pivot hole 12. Thus, when sway member pivot hole 12 and mount pivot hole 22 are aligned, the sway member pivot shaft 11 may be inserted so as to pivotally fasten sway member 10 onto primary vehicle 200. Alternatively, other structures or devices may be used to create a pivot effect, such as an integrated pivot shaft, a plurality of hydraulic pistons, hinges, etc.

A locking device such as locking U-bracket 26 may also be fastened to mounting bar 20, or other such structure, along the same longitudinal axis as sway member 10, but closer to the rear of primary vehicle 200. A plurality of slots or U-bracket locking holes 27 (not shown) within the arms of the locking U-bracket 26 and aligned transversely with respect to primary vehicle 200, enable sway member 10 to be locked or pinned in a stored or towing position. Optionally, a plurality of U-bracket locking holes 27 may be provided for locking sway member 10 in desired angles Thus, U-bracket locking holes 27 align with at least one corresponding sway member locking hole 17 located within sway member 10. Sway member locking holes 17 and U-bracket locking holes 27 are adapted to receive sway member locking pin 16. Sway member locking pin 16 may be of any configuration customary in the art, including bolts, quick release pins, or linchpins. Sway member 10 may thus be pivoted so as to move into or out of the open locking U-bracket 26 and locked into a desired angle. Other locking devices may also be used, such as friction clamps, indention clamps, spring clamps, hydraulic locks, adjustable tube clamps, or other such device adapted to clamp or hold the sway member fixed in the stored position with regards to the sway member.

A second portion of the present invention is telescope member 30. This piece may be fabricated of a material similar to that of sway member 10, and is capable of slide-ably engaging sway member 10. Telescope member 30 extends for towing and retracts for storage. In the example of FIG. 1, when sway member 10 is fabricated of hollow rectangular tubing, telescope member 30 is configured to slide within the hollow of sway member 10. Telescope member 30, extends from sway member 10 longitudinally, and preferably should extend beyond the rear of primary vehicle 200 when towing. Telescope member 30 and sway member 10 both feature a plurality of telescope locking holes 32 capable of being aligned as telescope member 30 is adjusted or extended within sway member 10 (as may be seen in FIG. 2.) Telescope locking holes 32 are adapted to receive telescope pin 31, such that when telescope pin 31 is inserted into telescope locking hole 32 passing through both telescope member 30 and sway member 10, then telescope member 30 is locked in place with respect to the level of extension from sway member 10. Other locking devices may also be used, such as friction clamps, indention clamps, spring clamps, hydraulic locks, adjustable tube clamps, or other such device adapted to clamp or hold the telescope member fixed in regards to the sway member. Optionally, telescope member 30 may be hydraulically actuated, extended by ratchet, motor and chain driven, or other mechanical means as known in the art. Alternatively, telescope member 30 and sway member 10 may be an integrated, hydraulic system where telescope member 30 is a piston riding a cylinder casing provided by sway member 10. Additional effort may be required to position a purely manual telescope member 30, as shown in FIG. 1. However, a simple embodiment may be lighter, more easily maintained, and less expensive.

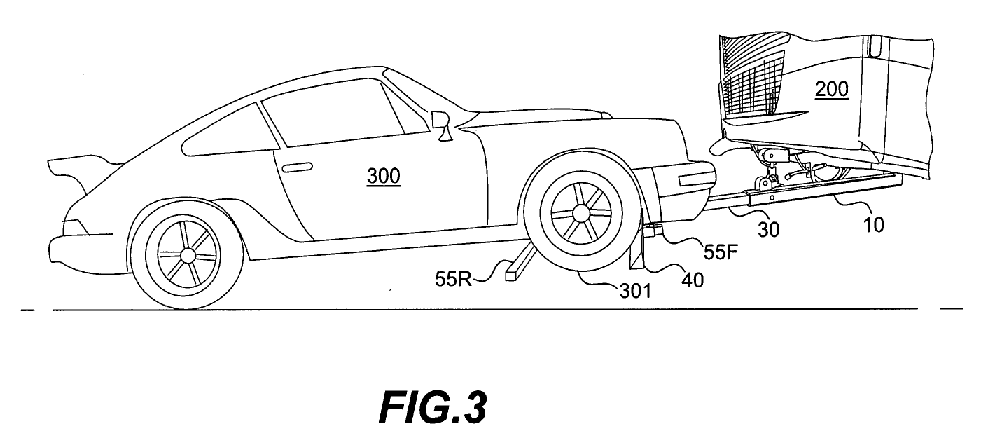

A third portion is swing member 40. This element may be fabricated of a material similar to sway member 10 and telescope member 30. Swing member 40 is pivotally and detachably fastened in its midsection to swing mount 33 located at the rear end of telescope member 30. The axis of pivot for swing mount 33 is vertical (i.e., the vertical axis runs top to bottom), and the pivot may be achieved in any detachable means known to those in the art, such as a notch, support, or tab riding in swing mount 33 defining a bearing for an independent swing member pivot shaft 41 (e.g., a separate pin or bolt, as shown in FIG. 1.) or an integrated shaft (not shown) formed from or part of swing member 40. Swing member 40 functions to bear secondary vehicle 300 and to connect it to primary vehicle 200, as shown in FIG. 3. Returning to FIG. 1, the pivoting function enables the towed secondary vehicle 300 to follow the primary vehicle 200 at an angle different from primary vehicle 200. Telescope member 30 with swing mount 33 should extend sufficiently out from sway member 10 and the rear end of primary vehicle 200 so as to enable swing member 40 to achieve desired angles without jackknifing or striking the towing primary vehicle 200. Optionally, telescope member 30 may include clearance stops or cutouts preventing swing member 40 from a full pivot.

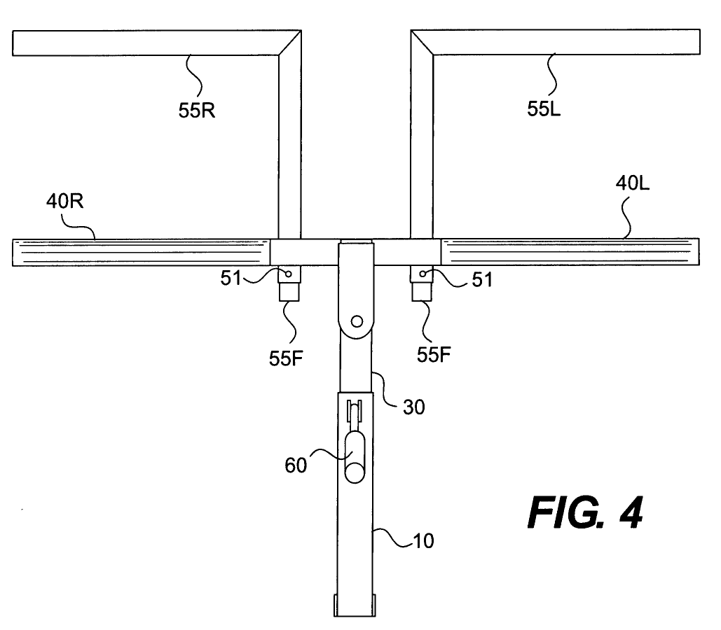

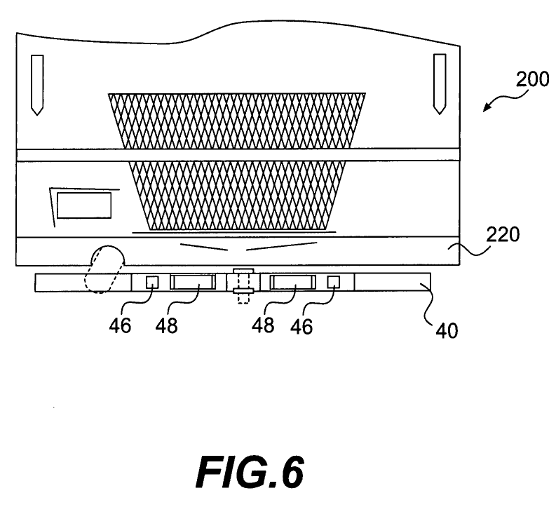

With reference to the top view in FIG. 4, swing member 40 mounts secondary vehicle 300 in order to operate as a tow lift. In this simple example, swing member 40 includes wheel mounts 55L and 55R for receiving a set of wheels/tires 301 of secondary vehicle 300. Preferably, wheel mounts 55L and 55R are adapted to detachably fix onto either end of swing member 40. Optionally, wheel mounts 55L and 55R may be configured to hinge or pivot out of way during storage. Thus, in the example shown in FIG. 4 (using a vehicle perspective), left end 40L of swing member 40 supports left wheel mount 55L, while right end 40R of swing member 40 supports right wheel mount 55R by wheel mount holes 46L and 46R (as may be seen in FIG. 6.)

Wheel mounts 55L and 55R may be fabricated in a variety of ways. The purpose of the wheel mounts is to provide a secure and convenient means for the secondary vehicle 300 to engage the tow lift 100. Those skilled in the art will readily see that the mounting function served by wheel mounts 55 in the above example may also be served by alternate embodiments, such as tow point hitches or devices designed to fasten to rigid portions of secondary vehicle 300. However, wheel mount 55, as shown in FIG. 4, is preferable in that it can provide secure transportation with simple, inexpensive structure.

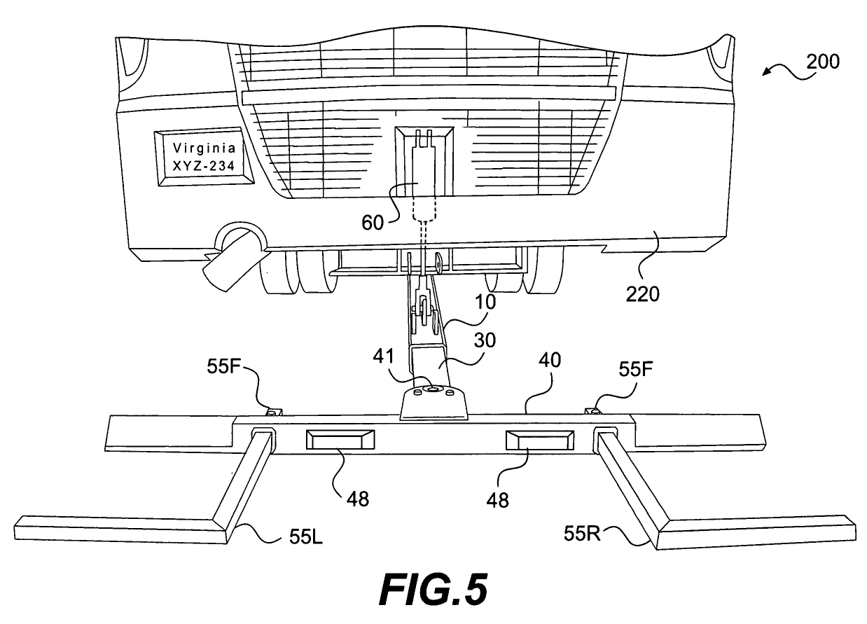

FIG. 5 is another view of simple wheel mounts 55L and 55R. In this example, each mount is L-shaped and fabricated of a tough material capable of bearing the weight of secondary vehicle 300. Preferably, wheel mounts 55 and swing member 40 are tapered or angled for the points at which they contact secondary vehicle 300 tires 301, so as to enable tires 301 to fit snugly. As may be seen in FIG. 6, swing member 40 may include wheel mount hole 46 or other mounting arrangement such as a socket or detent notch, into which wheel mount end 55F may be inserted. Wheel mount end 55F may include one or more wheel mount locking holes 52 by which wheel mounts 55 may be secured to swing member 40. Wheel mount locking holes 52 are designed to receive a wheel mount locking pin 51, such as a linchpin or bolt. Optionally, wheel mount 55 may include straps or chains to further secure tires 301 of secondary vehicle 300.

The basic operation of tow lift 100 may be described with reference to the drawings. Sway member 10 may be attached to the undercarriage of primary vehicle 200 by alignment of sway member pivot hole 12 with mount pivot hole 22 in sway member mount 21 and insertion of sway member pivot shaft 11. For a simple example, telescope member 30 is inserted into sway member 10, preferably with some form of lubrication, and adjusted to a desired level of extension. Telescope locking pin 31 may be inserted into a desired telescope locking hole 32 to lock telescope member 30 into place on sway member 10. With telescope member 30 extended from sway member 10, swing member 40 may be attached to the swing mount 33 of telescope member 30 using swing member pivot shaft 41. Left wheel mount 55L may be attached to left end 40L of swing member 40 and right wheel mount 55R may be attached to right end 40R of swing member 40. Secondary vehicle 300 may be driven into position adjacent to swing member 40. Wheel mounts 55L and 55R may be assembled about wheels/tires 301 of secondary vehicle 300, using wheel mount locking holes 52 and wheel mount locking pins 51. In a simple embodiment, a jack (not shown) may be used to elevate tow lift 100, with sway member 10 pivoting about sway member pivot shaft 11. When sway member locking hole 17 on sway member 10 aligns with a desired U-bracket locking hole 27 in U-bracket 26, then sway member locking pin 16 may be inserted into sway member locking hole 17, pinning sway member 10 into place. Optionally, sway member 10 may be adjusted pivotally by hydraulic piston 60 interposed between and attached to sway member 10 and the undercarriage or other suitable anchoring point on primary vehicle 200, as shown in FIG. 5. Those skilled in the art will acknowledge that other locking tabs and pins may be provided as desired.

With reference to FIG. 6, swing member 40 is designed to supplement primary vehicle 200 rear bumper 220. Typically, a bumper is designed to absorb the shock of impact and to reduce vehicle damage. The present invention tow lift 100 is configured such that sway member 10, mounting bar 20, telescope member 30, and swing member 40 may be positioned so as to place swing member 40 in the proximity of primary vehicle 200 rear bumper 220; in this way, swing member 40 serves as a supplemental bumper for primary vehicle 200 when tow lift 100 is in the stored position. Thus, preferably the dimensions and appearance of swing member 40 complement the rear body of secondary vehicle 300, to the extent possible while serving the aforementioned functions.

Bumpers are commonly made of a backing metal bar coupled with one or more means to absorb energy from an impact. Typical bumpers may include rubber, honeycomb elements, foam, or damping isolator pistons to absorb energy. Preferably, swing member 40 includes one or more of these energy absorbing elements. As shown in FIG. 6, swing member 40 may feature rubber pads 48 for shock absorption. With reference to FIG. 2, one or more supports 70 may be located on the undercarriage of primary vehicle 200 to brace swing member 40 in the event of impact. Optionally, stops 80 may be mounted onto damping isolator pistons 85 to provide protection comparable to that of standard bumpers. In general, isolator pistons are a piston and cylinder with compressed gas on one side and oil on the other, such that upon impact oil is forced through a small hole dissipating energy. Thus, the present invention may incorporate energy absorbing features to protect primary vehicle 200.

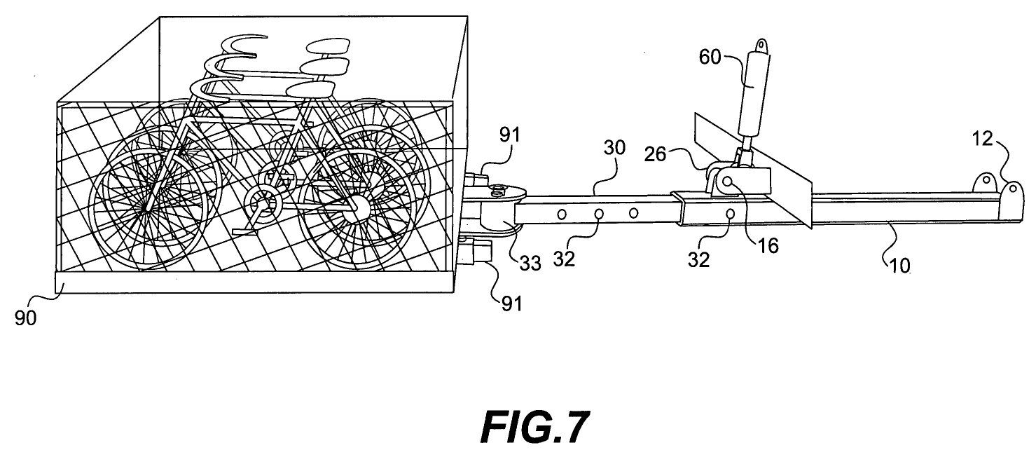

The present invention may be adapted to a variety of uses. For example, as shown in FIG. 7, wheel mounts 55 may be replaced with a rack or container such as meshed flat box 90, detachably fastened to swing bar 40, through box members 91. Those skilled in the art will recognize that in a similar way, tow lift 100 may be adapted for use in transporting items other than a secondary vehicle 300, such as motorcycles, all-terrain vehicles, golf carts, wheelchairs, jet skis, snow mobiles, tool boxes, luggage, etc. and other items, etc.

This contemplated arrangement for a tow lift may be achieved in a variety of configurations. While there has been described what is believed to be the preferred embodiment of the present invention, those skilled in the art will recognize that other and further changes and modifications may be made thereto without departing from the spirit of the invention, and it is intended to claim all such changes and modifications as fall within the true scope of the invention.

What is claimed is:

1. A dual purpose tow lift detachably mounted onto a primary vehicle having a front and rear end, said tow lift adapted to lifting and towing a secondary vehicle, wherein said tow lift comprises:
a sway member having a front and a rear end, wherein such sway member is substantially disposed along a longitudinal centerline of the primary vehicle, and where the front end of the sway member is detachably and pivotally mounted onto the primary vehicle undercarriage so that the sway member is capable of pivoting about a transverse axis of the primary vehicle, with the rear end of the sway member oriented to the rear end of the primary vehicle;
a locking device mounted onto the undercarriage of the primary vehicle, positioned along the longitudinal centerline of the sway member and configured to receive and lock the sway member in a position suitable for towing and storing;
a telescope member having a front and a rear end, detachably and slideably engaged with the sway member in a longitudinal manner, capable of being extended from the sway member in a longitudinal and rearward direction such that the telescope member may extend beyond the rear of the primary vehicle,
a locking device configured to lock the telescope member in a desired level of extension of telescope member from the sway member;
a swing member, having a left end, a midsection, and a right end, detachably and pivotally fastened at its midsection to the rear end of the telescope member in a substantially transverse manner in relation to the primary vehicle, wherein the swing member is capable of pivoting about a vertical axis;
a left wheel mount for receiving a left wheel of the secondary vehicle, capable of being detachably mounted onto the left end of the swing member, a right wheel mount for receiving a right wheel of the secondary vehicle, capable of being detachably mounted on the right end of the swing member, and
wherein said swing member is formed to provide a rear supplementing bumper for the primary vehicle when the sway member is locked in the stored position and when said telescope member is substantially retracted into said sway member and said swing member rests in a transverse position proximate to a rear bumper of the primary vehicle, and wherein said swing member is configured to align with the rear bumper to provide protection of the primary vehicle rear end in the event of a collision.

2. A dual purpose tow lift according to claim 1, further comprising a hydraulic system for raising and lowering the sway member about its axis of pivot, where the hydraulic system includes a piston detachably mounted to the primary vehicle and detachably mounted to the sway member.

3. The dual purpose tow lift according to claim 1, further comprising one or more supports, wherein the one or more supports are attached to the undercarriage of the primary vehicle so as to be adjacent to the swing bar when the tow lift is in the stored position, and are configured so as to reinforce the swing member when it serves as a rear supplementing bumper.

4. The dual purpose tow lift according to claim 1, further comprising one or more isolators, wherein the one or more isolators are disposed between the rear end of primary vehicle and the swing bar when the tow lift is in the stored position, and are configured so as to reinforce the swing member when it serves as a rear supplementing bumper.

5. The dual purpose tow lift according to claim 1, wherein the swing bar includes rubber pads.

6. The dual purpose tow lift according to claim 1, further comprising a hydraulic system for slideably extending, holding, and retracting telescope member with respect to the sway member.

7. The dual purpose tow lift according to claim 1, further comprising a container capable of being detachably mounted onto the swing member when the left and right wheel mounts are detached from the swing member.
